(19) United States
(12) Patent Application Publication
(10) Pub. No.: US 2025/0224894 A1
(43) Pub. Date: Jul. 10, 2025

(54) STORAGE DEVICE INCLUDING STORAGE CONTROLLER AND ELECTRONIC SYSTEM INCLUDING THE SAME

(71) Applicant: Samsung Electronics Co., Ltd., Suwon-si (KR)

(72) Inventor: YONG-TAEK JEONG, Suwon-si (KR)

(21) Appl. No.: 18/769,830

(22) Filed: Jul. 11, 2024

(30) Foreign Application Priority Data
Jan. 8, 2024 (KR) 10-2024-0003024

(51) Int. Cl. G06F 3/06

(52) U.S. Cl. CPC G06F 3/064; G06F 3/0604; G06F 3/0688

(57) ABSTRACT

A storage device includes a non-volatile memory storage comprising a first storage region and a second storage region, a first controller configured to control the first storage region, a second controller configured to control the second storage region, and a host interface configured to receive first data and first data type information representing a first data type of the first data, provide the first data to the first controller based on the first data type information, receive second data and second data type information representing a second data type of the second data, and provide the second data to the second controller based on the second data type information. The first data type of the first data is different from the second data type of the second data.

### CROSS-REFERENCE TO RELATED APPLICATION

This application claims priority to and the benefit of Korean Patent Application No. 10-2024-0003024 filed in the Korean Intellectual Property Office on Jan. 8, 2024, the entire contents of which is herein incorporated by reference.

### BACKGROUND OF THE INVENTION

### (a) Field of the Invention

The present disclosure relates to a storage device including a storage controller and an electronic system including the same.

### (b) Description of the Related Art

The vehicle may include a storage device that stores vehicle driving data generated while the vehicle is being driven. Compared to other types of data, the amount of the vehicle driving data may be enormous, and the number of write operations or read operations may be small. In a storage device having a plurality of cores that process data, if one core processes vehicle driving data and other types of data together, the time required for the storage device to perform an operation may increase.

### SUMMARY OF THE INVENTION

The present disclosure provides a storage device including a storage controller and an electronic system including the same, capable of efficiently process data related to vehicle driving.

According to an aspect of the present disclosure, a storage device includes a non-volatile memory storage comprising a first storage region and a second storage region, a first controller configured to control the first storage region, a second controller configured to control the second storage region, and a host interface configured to receive first data and first data type information representing a first data type of the first data, provide the first data to the first controller based on the first data type information, receive second data and second data type information representing a second data type of the second data, and provide the second data to the second controller based on the second data type information. The first data type of the first data is different from the second data type of the second data.

According to an aspect of the present disclosure, an electronic system includes a host processor generating first data related to vehicle driving information and second data related to an operation of the electronic system, a central controller generating a first data type information indicating that the first data is related to the vehicle driving information and a second data type information indicating that the second data is related to the operation of the electronic system, wherein the first data type information is different from the second data type information, and a storage device comprising a non-volatile storage comprising a first storage region and a second storage region. The storage device receives the first data and the first data type information from the central controller, stores the first data in the first storage region based on the first data type information, receives the second data and the second data type information from the central controller, and stores the second data in the second storage region based on the second data type information.

According to an aspect of the present disclosure, a storage controller includes a host core configured to receive first data having a write-intensive property and first data property information indicating that the first data have the write-intensive property through a channel connected to a host, receive second data having a normal property and second data property information indicating that the second data have the normal property through the channel, and transmit the first data and the second data to different control cores based on the first data property information and the second data property information, a first control core configured to store the first data in a first storage region of a non-volatile memory storage, and a second control core configured to store the second data in a second storage region of the non-volatile memory storage.

### BRIEF DESCRIPTION OF THE DRAWINGS

FIG. 1 is a drawing showing a vehicle according to an embodiment.

FIG. 2 is a drawing showing an electronic system according to an embodiment.

FIG. 3 is a drawing showing a host generating data type information according to an embodiment.

FIG. 4 is a drawing showing a storage device distributing data based on data type information according to an embodiment.

FIG. 5 is a drawing showing a non-volatile storage region storing data in different regions depending on types of data according to an embodiment.

FIG. 6 is a drawing showing a storage device generating map data according to an embodiment.

FIG. 7 is a drawing showing a storage device performing an error correction operation according to an embodiment.

FIG. 8 is a drawing showing a storage device storing data based on address information of a free block according to an embodiment.

FIG. 9 is a drawing showing a storage device updating map data according to an embodiment.

FIG. 10 is a drawing showing a storage device updating valid bit map data according to an embodiment.

FIG. 11 is a drawing showing an electronic system distributing based on data property information according to an embodiment.

FIG. 12 is a flowchart showing a method of distributing data based on data information in a storage device according to an embodiment.

FIG. 13 is a drawing of a configuration of a storage controller according to an embodiment.

FIG. 14 is a drawing of a configuration of a non-volatile memory device.

### DETAILED DESCRIPTION OF THE EMBODIMENTS

In the following detailed description, only certain embodiments of the present disclosure have been shown and described, simply by way of illustration. As those skilled in the art would realize, the described embodiments may be modified in various different ways, all without departing from the spirit or scope of the present invention.

Accordingly, the drawings and description are to be regarded as illustrative in nature and not restrictive. Like reference numerals designate like elements throughout the specification.

In addition, unless explicitly described to the contrary, the word “comprise”, and variations such as “comprises” or “comprising”, will be understood to imply the inclusion of stated elements but not the exclusion of any other elements.

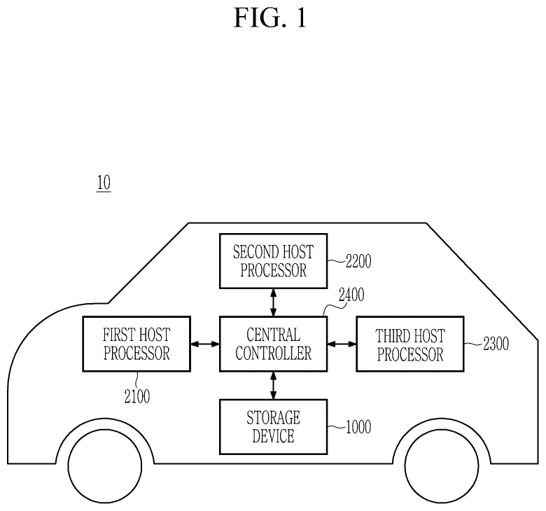

FIG. 1 is a drawing showing a vehicle according to an embodiment.

Referring to FIG. 1, a vehicle 10 may include a storage device 1000, a first host processor 2100, a second host processor 2200, a third host processor 2300, and a central controller 2400. The first host processor 2100, the second host processor 2200, and the third host processor 2300 may obtain vehicle driving information related to the driving of the vehicle 10, and generate processed data by processing the vehicle driving information. For example, the vehicle driving information may include the speed, location, brake state, driving time, or the like of the vehicle 10.

In an embodiment, the first host processor 2100, the second host processor 2200, and the third host processor 2300 may generate data representing the speed, location, brake operation state, driving time, and the like of the vehicle 10 based on the vehicle driving information.

In an embodiment, the vehicle driving information may include environmental information related to objects around the vehicle 10. The environmental information may include information about other vehicles, pedestrians, bicycles, and road signs around the vehicle 10. The environmental information may consist of image information detected by a plurality of sensors of the vehicle 10 regarding objects around the vehicle 10.

In an embodiment, the first host processor 2100, the second host processor 2200, and the third host processor 2300 may generate data representing a distance between the vehicle 10 and an object around the vehicle 10 based on the environmental information.

In an embodiment, the first host processor 2100, the second host processor 2200, and the third host processor 2300 may be processors of different types. For example, the first host processor 2100 may be a system-on-chip (SoC), the second host processor 2200 may be an application processor (AP), and the third host processor 2300 may be a micro control unit (MCU).

In an embodiment, the first host processor 2100, the second host processor 2200, and the third host processor 2300 may be disposed at different locations within the vehicle, depending on their types. Depending on the location disposed in the vehicle, the first host processor 2100, the second host processor 2200, and the third host processor 2300 may generate different data. For example, the first host processor 2100 may generate data representing a distance between the vehicle 10 and another vehicle, the second host processor 2200 may generate data representing the speed of the vehicle, and the third host processor 2300 may generate data representing the location of the vehicle.

The central controller 2400 may process data received from the first host processor 2100, the second host processor 2200, and the third host processor 2300. In an embodiment, the central controller 2400 may generate a meta data with respect to data received from the first host processor 2100, the second host processor 2200, and the third host processor 2300. In an embodiment, the meta data may include data type information representing a type of data which is related to information of a vehicle driving a road such as a distance to another vehicle, a speed of the vehicle, and a location thereof, which will be described. The meta data may include data property information representing properties of data such as a write-intensive property and a normal property, which will be described.

The central controller 2400 may control an operation of the storage device 1000. The central controller 2400 may control data received from the first host processor 2100, the second host processor 2200, and the third host processor 2300, to be stored in the storage device 1000.

The storage device 1000 may be a device that stores data according to the control of the central controller 2400. The storage device 1000 may be manufactured as various types of storage devices, such as solid-state drives (SSD) and others.

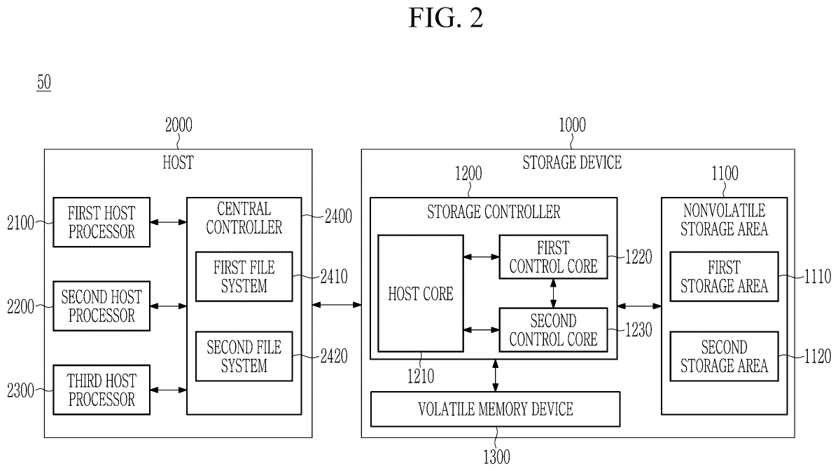

FIG. 2 is a drawing showing an electronic system according to an embodiment.

Referring to FIG. 2, an electronic system 50 may include the storage device 1000 and a host 2000. The electronic system 50 may be included in the vehicle 10 of FIG. 1.

The host 2000 may include the first host processor 2100, the second host processor 2200, the third host processor 2300, and the central controller 2400. The central controller 2400 may include a first file system 2410 and a second file system 2420.

In an embodiment, the first host processor 2100, the second host processor 2200, and the third host processor 2300 may generate vehicle driving data based on the vehicle driving information obtained in the driving of the vehicle 10. In an embodiment, the vehicle driving data may include data representing the speed, location, brake operation state, driving hours, or the like of the vehicle 10. In an embodiment, the vehicle driving data may include data representing the distance between the vehicle 10 and an object around the vehicle 10.

In an embodiment, the first host processor 2100, the second host processor 2200, and the third host processor 2300 may generate operation data used for an operation of the electronic system 50. The operation data used for the operation of the electronic system 50 may be data of a different type from the vehicle driving data.

In an embodiment, the first host processor 2100, the second host processor 2200, and the third host processor 2300 may generate the vehicle driving data and the operation data. The first host processor 2100, the second host processor 2200, and the third host processor 2300 may provide the vehicle driving data and the operation data to the central controller 2400. Specifically, the first host processor 2100, the second host processor 2200, and the third host processor 2300 may provide the vehicle driving data to the first file system 2410, and may provide the operation data to the second file system 2420.

In an embodiment, the first file system 2410 may process the vehicle driving data received from the first host processor 2100, the second host processor 2200, and the third host processor 2300. The first file system 2410 may provide the vehicle driving data to the storage device 1000.

In an embodiment, the first file system 2410 may be a system configured to process data having a write-intensive property. For example, the first file system 2410 may be a log-structured file system. The first file system 2410 may be a method and structure that an operating system (OS) of the central controller 2400 uses to manage and organize files on a storage device (e.g., the storage device 1000). For example, the first file system 2410 may provide a way to store, retrieve, and update data, ensuring that the driving data is structured and easily accessible. In an embodiment, the first file system 2410 may be implemented as part of the operating system's software stack, operating in an OS layer and interacting with the storage device via drivers. In an embodiment, the log-structured file system is a type of file system that treats a storage device as a continuous log, and is designed to improve performance, particularly with regard to write operations, and to simplify crash recovery.

Data having the write-intensive property may be data on which a read operation is performed only a small number of times. The data having write-intensive property may refer to data on which a write operation is repeatedly performed less frequently for data with the same logical address. For example, the data with write-intensive property may refer to data on which a low number of repeated write operations is performed, and the data may have the same logical block address (LBA). For example, the data which is subject to the overlapping write operations may have adjacent logical addresses in the same LBA. In an embodiment, the data having the write-intensive property may include the vehicle driving data.

In an embodiment, the second file system 2420 may process operation data received from the first host processor 2100, the second host processor 2200, and the third host processor 2300. The second file system 2420 may provide the operation data to the storage device 1000. In an embodiment, the second file system 2420 may be a file system of a different type from the first file system. For example, the second file system 2420 may be a file system configured to process data having a normal property.

Data having the normal property may refer to data for which the read operation is performed more frequently than the data having the write-intensive property. The data having the normal property may refer to data on which the write operation is repeatedly performed on data having the same logical address more frequently than the data having the write-intensive property. In an embodiment, the data having the normal properties may include the operation data related to the operation of the electronic system 50. For example, the normal property may be an attribute of the operation data. In an embodiment, the second file system 2420 may be a method and structure that the operating system (OS) of the central controller 2400 uses to manage and organize files on a storage device (e.g., the storage device 1000). For example, the second file system 2420 may provide a way to store, retrieve, and update data, ensuring that the operation data is structured and easily accessible. In an embodiment, the second file system 2420 may be implemented as part of the operating system's software stack, operating in the OS layer and interacting with the storage device via drivers.

The storage device 1000 may include a non-volatile storage region 1100 (i.e., a non-volatile memory storage), a storage controller 1200, and a volatile memory device 1300.

The non-volatile storage region 1100 may store data. The non-volatile storage region 1100 may operate in response to the control of control of the storage controller 1200.

In an embodiment, the non-volatile storage region 1100 may include a first storage region 1110 and a second storage region 1120. The first storage region 1110 and the second storage region 1120 may include a plurality of non-volatile memory devices. In an embodiment, the plurality of non-volatile memory devices may be a NAND flash memory. In an embodiment, the first storage region 1110 may correspond to a first range of a physical address of the non-volatile storage region 1100, and the second storage region 1120 may correspond to a second range of the physical address of the non-volatile storage region 1100.

The plurality of non-volatile memory devices may receive a command and a physical address from the storage controller 1200, and perform an operation instructed by the command with respect to a region selected by the physical address. The plurality of non-volatile memory devices may perform a program operation (write operation) of storing data in the region selected by the physical address, a read operation of reading data, or an erase operation of erasing data.

The storage controller 1200 may control the overall operation of the storage device 1000.

In an embodiment, when power is applied to the storage device 1000, the storage controller 1200 may execute firmware. The firmware may include a host interface layer controlling communication with the host 2000, a flash translation layer controlling communication between the host 2000 and the non-volatile storage region 1100, and a memory interface layer controlling communication with the non-volatile storage region 1100. The host interface layer, the flash translation layer, and the memory interface layer may be executed by a plurality of cores included in the storage controller 1200. In an embodiment, the storage controller 1200 may be a system-on-a-chip (SoC) including various reusable intellectual property cores implemented on a same substrate. For example, the storage controller 1200 may include a host core 1210, a first control core 1220, and a second control core 1230 which are fabricated on a same substrate. In an embodiment, the host core 1210 may execute the host interface layer. In an embodiment, the first control core 1220 and the second control core 1230 may execute the flash translation layer and the memory interface layer. The present disclosure is not limited thereto. For example, the host core 1210, the first control core 1220, and the second control core 1230 may be separate semiconductor chips. The first control core 1220 and the second control core 1230 may be formed in the same semiconductor chip. When the host core 1210, the first control core 1220, and the second control core 1230 may be formed in at least two semiconductor chips, those chips may correspond to chiplets to form the electronic system 50. Irrespective of ways of implementing the host core 1210, the first control core 1220, and the second control core 1230 in the electronic system 50, the host core 1210 may be a host interface or host interface circuit, the first control core 1220 may be a first controller or a first controller circuit, and the second control core 1230 may be a second controller or a second controller circuit.

In an embodiment, the flash translation layer may be a file translation layer which converts a logical address received from the host 2000 to a corresponding physical address of the non-volatile storage region 1100. The physical address may be an address representing a location at which data corresponding to the logical address is to be stored within the non-volatile storage region 1100. For example, the physical address may be a physical page address representing an address of page where data is to be stored. As an example, the physical address may be a physical block address representing an address of memory block where data is to be stored. In an embodiment, the translation layer may convert the logical address into a physical address having a block address and a page address.

In an embodiment, the storage controller 1200 may control the non-volatile storage region 1100 to perform the write operation (i.e., the program operation), the read operation, the erase operation, or the like according to a request of the host 2000. In the write operation, the storage controller 1200 may provide a write command, the physical address, and data to the non-volatile storage region 1100. In the read operation, the storage controller 1200 may provide a read command and the physical address to the non-volatile storage region 1100. In the erase operation, the storage controller 1200 may provide an erase command and the physical address to the non-volatile storage region 1100.

In an embodiment, the storage controller 1200 may include the host core 1210, the first control core 1220, and the second control core 1230. FIG. 2 illustrates, as an example, that the number of cores is 3. In an embodiment, the number of cores may be four or more.

In an embodiment, the host core 1210 may receive data, a write request indicating the storage of data, and a logical address from the host 2000. The host core 1210 may receive a read request instructing to read data from the host 2000 and a logical address from the host 2000. In an embodiment, the host core 1210 may provide the data and the logical address received from the host 2000 to the first control core 1220 or the second control core 1230.

In an embodiment, the host core 1210 may provide data to the first control core 1220 or the second control core 1230 based on the data type information representing the type of data. For example, the host core 1210 may provide data to one of the first control core 1220 and the second control core 1230 based on the data type information of the data. The data type information may represent the type of the data. In an embodiment, the host core 1210 may provide the first data including first data type information to the first control core 1220 based on first data type information. For example, the host core 1210 may determine the type of the data, and when determining that the data has the first data type information, provide the data to the first control core 1220. The first data may be the vehicle driving data related to vehicle driving. The first data type information may be information indicating that the first data are the vehicle driving data.

In an embodiment, the host core 1210 may provide the second data including the second data type information to the second control core 1230 based on second data type information. For example, the host core 1210 may determine the type of the data, and when determining that the data has the second data type information, provide the data to the second control core 1230. The second data may be the operation data used for the operation of the electronic system 50. The second data type information may be information indicating that the second data are operation data of the electronic system 50.

In an embodiment, the first control core 1220 and the second control core 1230 may control an operation of the non-volatile storage region 1100.

In more detail, the first control core 1220 may control an operation of the first storage region 1110, and a second control core 1230 may control an operation of the second storage region 1120. The first control core 1220 may control the write operation, the read operation, and the erase operation which are performed on the first storage region 1110. For example, the first control core 1220 may convert the logical address to the physical address in response to the write request received from the host 2000, and may provide the write command, data corresponding to the logical address, and the physical address to the first storage region 1110.

The second control core 1230 may control the write operation, the read operation, and the erase operation which are performed on the second storage region 1120. For example, the second control core 1230 may convert the logical address to the physical address in response to the write request received from the host 2000, and may provide the write command, data corresponding to the logical address, and the physical address to the second storage region 1120.

In an embodiment, the first control core 1220 and the second control core 1230 may control the non-volatile storage region 1100 to store data in the first storage region 1110 or the second storage region 1120 based on the data type information representing the type of data. In an embodiment, the first control core 1220 may be configured to store the first data in the first storage region 1110 based on the first data type information. The first data may be the vehicle driving data. In an embodiment, the second control core 1230 may be configured to store the second data in the second storage region 1120 based on the second data type information. The second data may be operation data of the electronic system 50.

The volatile memory device 1300 may temporarily store the data provided from the host 2000, or may temporarily store the data read from the non-volatile storage region 1100. In an embodiment, the volatile memory device 1300 may be dynamic random access memory (DRAM) or static random access memory (SRAM). In an embodiment, the volatile memory device 1300 may be located outside the storage controller 1200, and may be located inside the storage controller 1200.

In an embodiment, the volatile memory device 1300 may store meta data. The meta data may be data including information used for the operation of the storage device 1000. In an embodiment, the meta data may include map data representing mapping relationship between the logical address of the host 2000 and the physical address of the non-volatile storage region 1100. In an embodiment, the meta data may include valid bit map data representing whether the data stored in a plurality of memory blocks included in the non-volatile storage region 1100 is valid data. The meta data may be updated by the first control core 1220 and the second control core 1230.

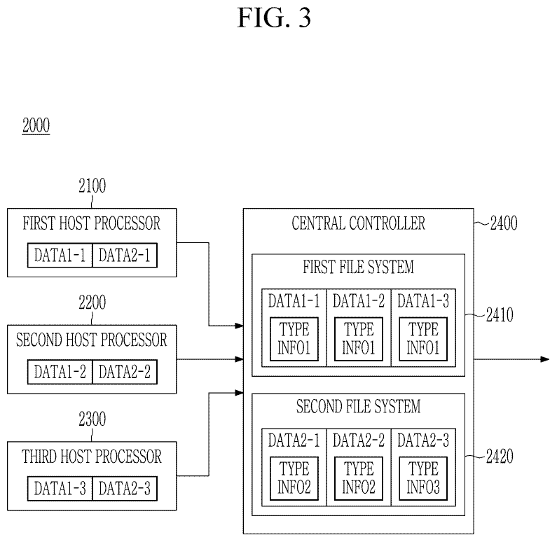

FIG. 3 is a drawing showing a host generating the data type information according to an embodiment.

Referring to FIG. 3, the host 2000 may include the first host processor 2100, the second host processor 2200, the third host processor 2300, and the central controller 2400. The central controller 2400 may include the first file system 2410 and the second file system 2420.

In an embodiment, the first host processor 2100, the second host processor 2200, and the third host processor 2300 may generate the first data and the second data of a different type from the first data related to vehicle driving. The first data may include a 1-1st sub-data DATA1-1, a 1-2nd sub-data DATA1-2, and a 1-3rd sub-data DATA1-3.

In an embodiment, the first data may include the vehicle driving data generated in driving of the vehicle 10. In an embodiment, the vehicle driving data may include data generated while the vehicle is under autonomous driving. For example, the vehicle driving data may include data representing the distance between the vehicle 10 and another vehicle, the speed of the vehicle, the location of the vehicle, or the like, during the autonomous driving of the vehicle 10. As an example, the vehicle driving data may include data related to accident occurred while the vehicle 10 is autonomously driven. Specifically, the data related to accident may include data indicating the accelerator pedal operation state, brake pedal state, engine state, or seat belt wearing state of the vehicle 10.

The second data may be data of a different type from the first data. The second data may include operation data used for the operation of the electronic system 50. The second data may include a 2-1st sub-data DATA2-1, a 2-2nd sub-data DATA2-2, and a 2-3rd sub-data DATA2-3.

In more detail, the first host processor 2100 may generate the 1-1st sub-data DATA1-1 and the 2-1st sub-data DATA2-1. For example, the 1-1st sub-data DATA1-1 may be data configured to represent the distance between the vehicle 10 and another vehicle.

The second host processor 2200 may generate the 1-2nd sub-data DATA1-2 and the 2-2nd sub-data DATA2-2. For example, the 1-2nd sub-data DATA1-2 may be data configured to represent speed of the vehicle 10.

The third host processor 2300 may generate the 1-3rd sub-data DATA1-3 and the 2-3rd sub-data DATA2-3. For example, the 1-3rd sub-data DATA1-3 may be data configured to represent location of the vehicle 10.

In an embodiment, the first host processor 2100, the second host processor 2200, and the third host processor 2300 may provide the first data to the first file system 2410 related to the driving of the vehicle 10, and may provide the second data of a different type from the first data to the second file system 2420.

In more detail, the first host processor 2100, the second host processor 2200, and the third host processor 2300 may provide the 1-1st sub-data DATA1-1, the 1-2nd sub-data DATA1-2, and the 1-3rd sub-data DATA1-3 to the first file system 2410. In an embodiment, the first host processor 2100, the second host processor 2200, and the third host processor 2300 may provide the 1-1st sub-data DATA1-1, the 1-2nd sub-data DATA1-2, and the 1-3rd sub-data DATA1-3 to the first file system 2410, respectively. The first host processor 2100, the second host processor 2200, and the third host processor 2300 may provide the 2-1st sub-data DATA2-1, the 2-2nd sub-data DATA2-2, and the 2-3rd sub-data DATA2-3 to the second file system 2420. In an embodiment, the first host processor 2100, the second host processor 2200, and the third host processor 2300 may provide the 2-1st sub-data DATA2-1, the 2-2nd sub-data DATA2-2, and the 2-3rd sub-data DATA2-3 to the second file system 2420, respectively.

The first file system 2410 may receive the first data related to driving of the vehicle from the first host processor 2100, the second host processor 2200, and the third host processor 2300, and may generate the data type information representing a type of the first data.

In more detail, the first file system 2410 may generate the first data type information TYPE INFO1 indicating that the 1-1st sub-data DATA1-1, the 1-2nd sub-data DATA1-2, and the 1-3rd sub-data DATA1-3 are the vehicle driving data. The first file system 2410 may provide the 1-1st sub-data DATA1-1, the 1-2nd sub-data DATA1-2, and the 1-3rd sub-data DATA1-3 including the first data type information TYPE INFO1 to the storage device 1000. For example, each of the 1-1st sub-data DATA1-1, the 1-2nd sub-data DATA1-2, and the 1-3rd sub-data DATA1-3 may include the first data type information TYPE INFO1.

The second file system 2420 may receive the second data from the first host processor 2100, the second host processor 2200, and the third host processor 2300, and may generate the data type information representing a type of the second data. Specifically, the second file system 2420 may generate the second data type information TYPE INFO2 representing types of the 2-1st sub-data DATA2-1 and the 2-2nd sub-data DATA2-2, and may generate a third data type information TYPE INFO3 representing a type of the 2-3rd sub-data DATA2-3. The 2-1st sub-data DATA2-1 and the 2-2nd sub-data DATA2-2 may be data of the same type. The 2-1st sub-data DATA2-1 and the 2-2nd sub-data DATA2-2 may be data of a different type from the 2-3rd sub-data DATA2-3. The second data type information TYPE INFO2 may be information indicating that the 2-1st sub-data DATA2-1 and the 2-2nd sub-data DATA2-2 are data associated with power management of the electronic system 50. The third data type information TYPE INFO3 may be information indicating that the 2-3rd sub-data DATA2-3 are data associated with an operating system or an application executed by the host 2000.

The second file system 2420 may provide the 2-1st sub-data DATA2-1 and the 2-2nd sub-data DATA2-2 including the second data type information TYPE INFO2 to the storage device 1000. The second file system 2420 may provide the 2-3rd sub-data DATA2-3 including the third data type information TYPE INFO3 to the storage device 1000.

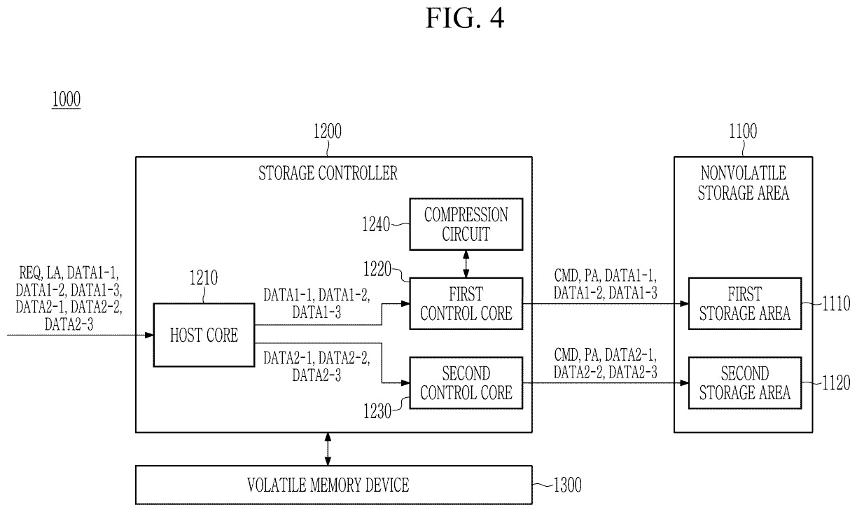

FIG. 4 is a drawing showing a storage device distributing data based on the data type information according to an embodiment.

Referring to FIG. 4, the storage device 1000 may include the non-volatile storage region 1100, the storage controller 1200, and the volatile memory device 1300. The non-volatile storage region 1100 may include the first storage region 1110 and the second storage region 1120. The storage controller 1200 may include the host core 1210, the first control core 1220, the second control core 1230, and a compression circuit 1240.

In an embodiment, the host core 1210 may receive the write request REQ, the logical address LA, the 1-1st sub-data DATA1-1, the 1-2nd sub-data DATA1-2, and the 1-3rd sub-data DATA1-3 from the first file system 2410. The 1-1st sub-data DATA1-1, the 1-2nd sub-data DATA1-2, and the 1-3rd sub-data DATA1-3 may include the first data type information indicating that it is the vehicle driving data.

The host core 1210 may receive the write request REQ, the logical address LA, the 2-1st sub-data DATA2-1, the 2-2nd sub-data DATA2-2, and the 2-3rd sub-data DATA2-3 from the second file system 2420. The 2-1st sub-data DATA2-1 and the 2-2nd sub-data DATA2-2 may include the second data type information. The 2-3rd sub-data DATA2-3 may include the third data type information.

In an embodiment, the logical addresses corresponding to the 1-1st sub-data DATA1-1, the 1-2nd sub-data DATA1-2, the 1-3rd sub-data DATA1-3, the 2-1st sub-data DATA2-1, the 2-2nd sub-data DATA2-2, and the 2-3rd sub-data DATA2-3, respectively, may be different.

In an embodiment, the host core 1210 may sequentially receive the 1-1st sub-data DATA1-1, the 1-2nd sub-data DATA1-2, the 1-3rd sub-data DATA1-3, the 2-1st sub-data DATA2-1, the 2-2nd sub-data DATA2-2, and the 2-3rd sub-data DATA2-3 from the first file system 2410 and the second file system 2420 through one same channel connected to the host 2000. For example, the host core 1210 may sequentially receive the 1-1st sub-data DATA1-1, the 1-2nd sub-data DATA1-2, and the 1-3rd sub-data DATA1-3 from the first file system 2410, and the 2-1st sub-data DATA2-1, the 2-2nd sub-data DATA2-2, and may sequentially receive the 2-3rd sub-data DATA2-3 from the second file system 2420. The sequence in which respective sub-data are received may be changed.

In an embodiment, the host core 1210 may distribute data received from the first file system 2410 and the second file system 2420 to the first control core 1220 or the second control core 1230 based on the data type information representing the type of data.

In more detail, the host core 1210 may provide the 1-1st sub-data DATA1-1, the 1-2nd sub-data DATA1-2, and the 1-3rd sub-data DATA1-3 including the first data type information to the first control core 1220 based on the first data type information. The first data type information may be information indicating that the 1-1st sub-data DATA1-1, the 1-2nd sub-data DATA1-2, and the 1-3rd sub-data DATA1-3 are the vehicle driving data.

The host core 1210 may provide the 2-1st sub-data DATA2-1 and the 2-2nd sub-data DATA2-2 including the second data type information to the second control core 1230 based on based on the second data type information. The host core 1210 may provide the 2-3rd sub-data DATA2-3 including the third data type information to the second control core 1230 based on based on the third data type information. The second data type information and the third data type information may be information indicating that the 2-1st sub-data DATA2-1, the 2-2nd sub-data DATA2-2, and the 2-3rd sub-data DATA2-3 are of a different type from the vehicle driving data.

In an embodiment, the first control core 1220 may provide a write command CMD, a physical address PA, the 1-1st sub-data DATA1-1, the 1-2nd sub-data DATA1-2, and the 1-3rd sub-data DATA1-3 to the first storage region 1110. The 1-1st sub-data DATA1-1, the 1-2nd sub-data DATA1-2, and the 1-3rd sub-data DATA1-3 may be stored in a region corresponding to the physical address PA within the first storage region 1110 according to the write command CMD.

In an embodiment, the compression circuit 1240 may compress data received from the first control core 1220, and may provide the compressed data to the first control core 1220. In an embodiment, the first control core 1220 may provide the 1-1st sub-data DATA1-1, the 1-2nd sub-data DATA1-2, and the 1-3rd sub-data DATA1-3 to the compression circuit 1240. The compression circuit 1240 may provide the compression data of the 1-1st sub-data DATA1-1, the 1-2nd sub-data DATA1-2, and the 1-3rd sub-data DATA1-3 to the first control core 1220. The first control core 1220 may provide the write command CMD, the physical address PA, and compression data to the first storage region 1110.

In an embodiment, the second control core 1230 may provide the write command CMD, the physical address PA, the 2-1st sub-data DATA2-1, the 2-2nd sub-data DATA2-2, and the 2-3rd sub-data DATA2-3 to the second storage region 1120. The 2-1st sub-data DATA2-1, the 2-2nd sub-data DATA2-2, and the 2-3rd sub-data DATA2-3 may be stored in a region corresponding to the physical address PA within the second storage region 1120 according to the write command CMD.

In an embodiment, the vehicle driving data may be data generated while the vehicle is under autonomous driving. The vehicle driving data may be continuously generated by the host 2000 while the vehicle is under the autonomous driving. In addition, the storage device 1000 may continuously store the vehicle driving data generated during the autonomous driving. If one control core included the storage device 1000 processes the vehicle driving data and data of a different type from the vehicle driving data together, which is received continuously, the efficiency may be low.

In addition, the vehicle driving data may be the data having the write-intensive property. The data having the write-intensive property may have a smaller number of the read operations unlike the data having the normal property. In addition, unlike the data having the normal property, the data having the write-intensive property may have smaller number of times change to invalid data as the write operations are repeated. The write amplification factor (WAF) with respect to the data having the write-intensive property may be close to 1, and the WAF with respect to the data having the normal property may be greater than WAF with respect to the data having the write-intensive property.

Since the operation performed on the data having the write-intensive property may be different from the operation performed on the data having the normal property, in types and count, it may not be efficient that one control core included the storage device 1000 processes the data having the write-intensive property and the data having the normal property together.

Accordingly, the host core 1210 of the storage device 1000 may provide the vehicle driving data and data of a different type from the vehicle driving data to different control cores based on the data type information representing the type of data. The first control core 1220 may only process the vehicle driving data, and the second control core 1230 may process data of a different type from the vehicle driving data. Since the first control core 1220 and the second control core 1230 process different types of data, efficiency of data processing may be increased, and performance of the storage device 1000 may be improved.

In addition, since the first control core 1220 exclusively processes the vehicle driving data and the first storage region controlled by the first control core is allocated as a dedicated region for storing the vehicle driving data, there may not be a need to separately provide a storage device for storing data related to the driving of the vehicle 10 such as the event data recorder (EDR) and data storage system for autonomous driving (DSSAD) within the vehicle 10.

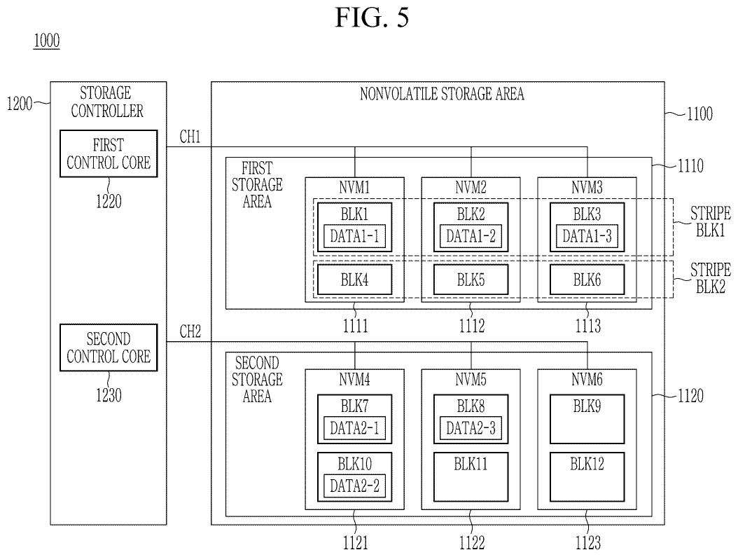

FIG. 5 is a drawing showing a non-volatile storage region storing data in different regions depending on the type of data according to an embodiment.

Referring to FIG. 5, the storage device 1000 may include the non-volatile storage region 1100 and the storage controller 1200. The storage controller 1200 may include the first control core 1220 and the second control core 1230. The non-volatile storage region 1100 may include the first storage region 1110 and the second storage region 1120.

Each of the first storage region 1110 and the second storage region 1120 may include the plurality of non-volatile memory devices. FIG. 5 illustrates, as an example, that each of the first storage region 1110 and the second storage region 1120 includes three non-volatile memory devices. The number of non-volatile memory devices included in the first storage region 1110 and the second storage region 1120 may be two or less or four or more.

In an embodiment, the first storage region 1110 may include a first non-volatile memory device 1111, a second non-volatile memory device 1112, and a third non-volatile memory device 1113. The second storage region 1120 may include a fourth non-volatile memory device 1121, a fifth non-volatile memory device 1122, and a sixth non-volatile memory device 1123.

The plurality of non-volatile memory devices each may include a plurality of memory blocks. In an embodiment, one memory block may be a unit of an erase operation in each non-volatile memory device. For example, the entire single memory block may be erased in an erase operation. In an embodiment, the first non-volatile memory device 1111 may include a first memory block BLK1 and a fourth memory block BLK4. The second non-volatile memory device 1112 may include a second memory block BLK2 and a fifth memory block BLK5. The third non-volatile memory device 1113 may include a third memory block BLK3 and a sixth memory block BLK6. In an embodiment, the number of memory blocks included in the non-volatile memory device may be three or more.

The first to third non-volatile memory devices 1111 to 1113 may communicate with the storage controller 1200 through a first channel CH1. In an embodiment, the first control core 1220 may control the operation of the first to third non-volatile memory devices 1111 to 1113 included the first storage region 1110 through the first channel CH1.

In an embodiment, the first control core 1220 may provide the write command, the physical address, and data to the first to third non-volatile memory devices 1111 to 1113 through the first channel CH1. The first to third non-volatile memory devices 1111 to 1113 may perform overlapping write operations to store data in response to write commands. In the overlapping write operations, the first control core 1220 may receive multiple write request targeting the same logical block address (or adjacent addresses) concurrently, and the first control core 1220 may generate multiple write commands, and physical addresses to store the data in the first to third non-volatile memory devices 1111 to 1113.

The fourth to sixth non-volatile memory devices 1114 to 1116 may communicate with the storage controller 1200 through a second channel CH2. In an embodiment, the second control core 1230 may control the operation of the fourth to sixth non-volatile memory devices 1121 to 1123 included the second storage region 1120 through the second channel CH2.

In an embodiment, the first control core 1220 may configure the plurality of memory blocks included in the first to third non-volatile memory devices 1111 to 1113 as a plurality of stripe blocks. The plurality of stripe blocks each may include memory blocks included in different non-volatile memory devices.

In an embodiment, the first control core 1220 may configure the first memory block BLK1 included in the first non-volatile memory device 1111, the second memory block BLK2 included in the second non-volatile memory device 1112, and the third memory block BLK3 included the third non-volatile memory device 1113 as a first stripe block STRIPE BLK1. In an embodiment, the first memory block BLK1, the second memory block BLK2, and the third memory block BLK3 may have the same physical block address in the first to third non-volatile memory devices 1111 to 1113, which may facilitate the configuration of the plurality of stripe blocks. In an embodiment, the first control core 1220 may configure the fourth memory block BLK4 included in the first non-volatile memory device 1111, the fifth memory block BLK5 included in the second non-volatile memory device 1112, and the sixth memory block BLK6 included the third non-volatile memory device 1113 as a second stripe block STRIPE BLK2.

In an embodiment, the first control core 1220 may control the first storage region 1110 to store vehicle driving data in stripe block units. For example, when the vehicle 10 is driving autonomously or equipped with sensors, it stores driving data (i.e., driving information) in the electronic system 50 with the storage device 1000. For example, If the sensors collect data every second, this data, including a distance to another vehicle of the 1-1st sub-data DATA1-1, a vehicle speed of the 1-2nd sub-data DATA1-2, and a location of the vehicle 10 of the 1-3rd sub-data DATA1-3, is stored consecutively. The first control core 1220 may configure the first storage region 1110 in multiple stripe blocks to facilitate data storage and retrieval of the driving data collected at different times. Thus, the sub-data DATA1-1, DATA1-2, and DATA1-3 generated simultaneously may be stored in the same stripe block. In other words, data stored in the same stripe block may correspond to data collected at the same time during a time when the vehicle 10 is running on a road.

In more detail, the first control core 1220 may receive the 1-1st sub-data DATA1-1, the 1-2nd sub-data DATA1-2, and the 1-3rd sub-data DATA1-3 including the first data type information indicating that it is the vehicle driving data. The first control core 1220 may provide the write command, first physical address corresponding to the first memory block BLK1, and the 1-1st sub-data DATA1-1 to the first non-volatile memory device 1111 through the first channel CH1, may provide the write command, second physical address corresponding to the second memory block BLK2, and the 1-2nd sub-data DATA1-2 to the second non-volatile memory device 1112, and may provide the write command, third physical address corresponding to the third memory block BLK3, and the 1-3rd sub-data DATA1-3 to the third non-volatile memory device 1113.

The first non-volatile memory device 1111 may perform the write operation of storing the 1-1st sub-data DATA1-1 in the first memory block BLK1, the second non-volatile memory device 1112 may perform the write operation of storing the 1-2nd sub-data DATA1-2 in the second memory block BLK2, and the third non-volatile memory device 1113 may perform the write operation of storing the 1-3rd sub-data DATA1-3 in the third memory block BLK3. The first to third non-volatile memory devices 1111 to 1113 may perform overlapping write operations of storing the 1-1st sub-data DATA1-1, the 1-2nd sub-data DATA1-2, and the 1-3rd sub-data DATA1-3. The 1-1st sub-data DATA1-1, the 1-2nd sub-data DATA1-2, and the 1-3rd sub-data DATA1-3 Including the first data type information indicating that it is the vehicle driving data may be stored in the first stripe block STRIPE BLK1.

In an embodiment, the second control core 1230 may control the second storage region 1120 to store data of a different type from the vehicle driving data in memory block units according to the type of data.

In more detail, the second control core 1230 may receive the 2-1st sub-data DATA2-1 and the 2-2nd sub-data DATA2-2 including the second data type information, and the 2-3rd sub-data DATA2-3 including the third data type information. The second control core 1230 may provide the write command, seventh physical address corresponding to a seventh memory block BLK7, tenth physical address corresponding to a tenth memory block BLK10, the 2-1st sub-data DATA2-1, and the 2-2nd sub-data DATA2-2 to the fourth non-volatile memory device 1121 through the second channel CH2, and may provide the write command, eighth physical address corresponding to eighth memory block BLK8, and the 2-3rd sub-data DATA2-3 to the fifth non-volatile memory device 1122.

The fourth non-volatile memory device 1121 may store the 2-1st sub-data DATA2-1 in the seventh memory block BLK7, may perform the write operation of storing the 2-2nd sub-data DATA2-2 in the tenth memory block BLK10, and the fifth non-volatile memory device 1122 may perform the write operation of storing the 2-3rd sub-data DATA2-3 in the eighth memory block BLK8.

The fourth to fifth non-volatile memory devices 1121 and 1122 may perform overlapping write operations of storing the 2-1st sub-data DATA2-1 and the 2-3rd sub-data DATA2-3. The fourth non-volatile memory device 1121 may perform the write operation of storing the 2-1st sub-data DATA2-1 in the overlapping write operations, and then perform the write operation of storing the 2-2nd sub-data DATA2-2.

In an embodiment, the second control core 1230 may provide data including the same data type information to the same non-volatile memory device. The 2-1st sub-data DATA2-1 and the 2-2nd sub-data DATA2-2 including the same data type information may be stored in the fourth non-volatile memory device 1121. The 2-3rd sub-data DATA2-3 including the data type information different from the 2-1st sub-data DATA2-1 and the 2-2nd sub-data DATA2-2 may be stored in the fifth non-volatile memory device 1122.

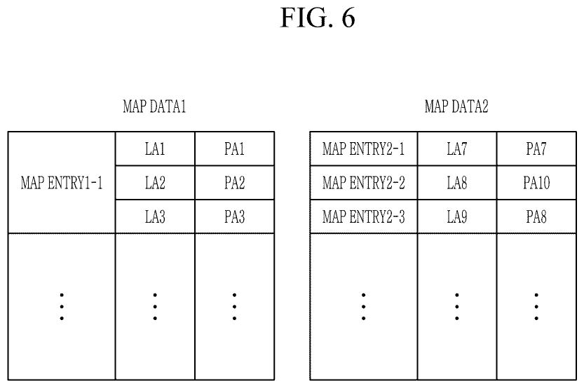

FIG. 6 is a drawing showing a storage device generating map data according to an embodiment.

FIG. 6 will be explained with reference to FIG. 5. Referring to FIG. 6, the storage controller 1200 may store the first data related to vehicle driving and the second data of a different type from the first data in the non-volatile storage region 1100, and may generate the map data with respect to the first data and the second data. The map data may be data representing mapping relationship between the logical address of the host 2000 and the physical address of the non-volatile storage region 1100. The map data may include a plurality of map entries. The map entry may include data representing mapping relationship between at least one the logical address and the physical address. In an embodiment, the map entry may be the unit that the storage controller 1200 reads data.

In an embodiment, the first data may include the 1-1st sub-data DATA1-1, the 1-2nd sub-data DATA1-2, and the 1-3rd sub-data DATA1-3. The second data may include the 2-1st sub-data DATA2-1, the 2-2nd sub-data DATA2-2, and the 2-3rd sub-data DATA2-3.

In an embodiment, the first control core 1220 may generate a first map data MAP DATA1 with respect to data stored in the first storage region 1110. Specifically, the first control core 1220 may generate a 1-1st map entry MAP ENTRY1-1 with respect to the 1-1st sub-data DATA1-1 stored in the first stripe block STRIPE BLK1, the 1-2nd sub-data DATA1-2, and the 1-3rd sub-data DATA1-3. The first control core 1220 may generate the 1-1st map entry MAP ENTRY1-1 which maps a first logical address LA1 and a first physical address PA1, maps a second logical address LA2 and a second physical address PA2, and maps a third logical address LA3 and a third physical address PA3.The first logical address LA1 may correspond to the 1-1st sub-data DATA1-1, and the first physical address PA1 may correspond to the address of the first memory block BLK1 storing the 1-1st sub-data DATA1-1. The second logical address LA2 may correspond to the 1-2nd sub-data DATA1-2, and the second physical address PA2 may correspond to the address of the second memory block BLK2 storing the 1-2nd sub-data DATA1-2. The third logical address LA3 may correspond to the 1-3rd sub-data DATA1-3, and the third physical address PA3 may correspond to the address of the third memory block BLK3 storing the 1-3rd sub-data DATA1-3.

In an embodiment, the second control core 1230 may generate a second map data MAP DATA2 with respect to data stored in the second storage region 1120. Specifically, the second control core 1230 may generate a 2-1st map entry MAP ENTRY2-1 with respect to the 2-1st sub-data DATA2-1 stored in the seventh memory block BLK7, a 2-2nd map entry MAP ENTRY2-2 with respect to the 2-2nd sub-data DATA2-2 stored in the tenth memory block BLK10, and a 2-3rd map entry MAP ENTRY2-3 with respect to the 2-3rd sub-data DATA2-3 stored in the eighth memory block BLK8.

The second control core 1230 may generate the 2-1st map entry MAP ENTRY2-1 which maps a seventh logical address LA7 and seventh physical address. The seventh logical address LA7 may correspond to the 2-1st sub-data DATA2-1. A seventh physical address PA7 may correspond to the address of the seventh memory block BLK7 storing the 2-1st sub-data DATA2-1.

The second control core 1230 may generate the 2-2nd map entry MAP ENTRY2-2 which maps an eighth logical address LA8 and tenth physical address. The eighth logical address LA8 may correspond to the 2-2nd sub-data DATA2-2. A tenth physical address PA10 may correspond to the address of the tenth memory block BLK10 storing the 2-2nd sub-data DATA2-2.

The second control core 1230 may generate the 2-3rd map entry MAP ENTRY2-3 which maps a ninth logical address LA9 and eighth physical address. The ninth logical address LA9 may correspond to the 2-3rd sub-data DATA2-3. An eighth physical address PA8 may correspond to the address of the eighth memory block BLK8 storing the 2-3rd sub-data DATA2-3.

In an embodiment, the 1-1st map entry MAP ENTRY1-1 may include data representing three mapping relationships. Each of the 2-1st map entry MAP ENTRY2-1, the 2-2nd map entry MAP ENTRY2-2, and the 2-3rd map entry MAP ENTRY2-3 may include data representing one mapping relationship. The size of the 1-1st map entry MAP ENTRY1-1 may be greater than the 2-1st map entry MAP ENTRY2-1, the 2-2nd map entry MAP ENTRY2-2, or the size of the 2-3rd map entry MAP ENTRY2-3.

In an embodiment, the 1-1st map entry MAP ENTRY1-1 is the map data on the first data related to vehicle driving, so the number of repeatedly performing the write operation on the same logical address may be small, and accordingly, the number of updating the 1-1st map entry MAP ENTRY1-1 may be small. Therefore, even if the first control core 1220 increase the size of the 1-1st map entry MAP ENTRY1-1 to be larger than the size of the 2-1st map entry MAP ENTRY2-1, the 2-2nd map entry MAP ENTRY2-2, or the 2-3rd map entry MAP ENTRY2-3, they may be efficiently managed without deteriorating performance of the storage device 1000 may not deteriorated.

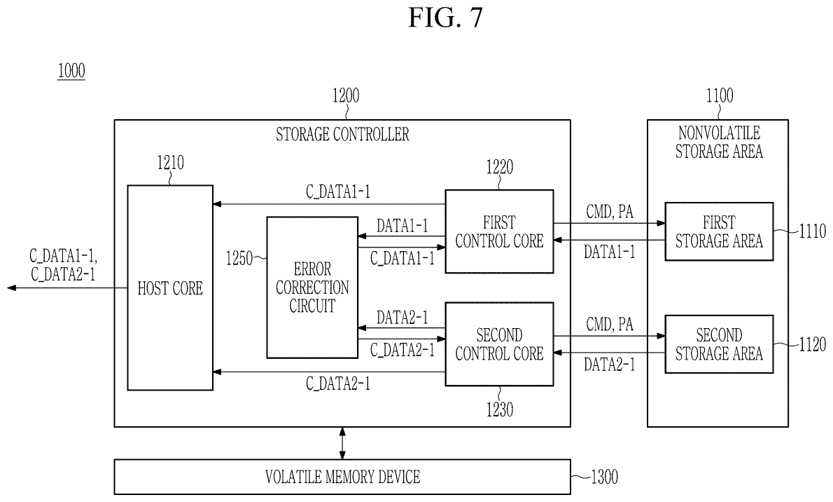

FIG. 7 is a drawing showing a storage device performing an error correction operation according to an embodiment.

Referring to FIG. 7, the storage controller 1200 may include the host core 1210, the first control core 1220, the second control core 1230, and an error correction circuit 1250.

In an embodiment, the storage controller 1200 may read data stored in the non-volatile storage region 1100 in response to a read request received from the host 2000, may perform the error correction operation of correcting at least one error bit included in the read data, and may provide the error-corrected data to the host 2000.

In an embodiment, the first control core 1220 may provide a read command CMD and the physical address PA. In an embodiment, the physical address PA may be the address of the first memory block BLK1 storing the 1-1st sub-data DATA1-1. The first storage region 1110 may perform the read operation of reading the 1-1st sub-data DATA1-1 stored in the first memory block BLK1 in response to the read command CMD, and may provide the 1-1st sub-data DATA1-1 to the first control core 1220. The first control core 1220 may provide the 1-1st sub-data DATA1-1 received from the first storage region 1110 to the error correction circuit 1250.

In an embodiment, the second control core 1230 may provide the read command CMD and the physical address PA. In an embodiment, the physical address PA may be the address of the seventh memory block BLK7 storing the 2-1st sub-data DATA2-1. The second storage region 1120 may perform the read operation of reading the 2-1st sub-data DATA2-1 stored in the seventh memory block BLK7 in response to the read command CMD, and may provide the 2-1st sub-data DATA2-1 to the second control core 1230. The second control core 1230 may provide the 2-1st sub-data DATA2-1 received from the second storage region 1120 to the error correction circuit 1250. In an embodiment, the error correction circuit 1250 may perform an error correction operation of correcting the error bit included the 1-1st sub-data DATA1-1 and the 2-1st sub-data DATA2-1. The error correction circuit 1250 may correct at least error bit included the 1-1st sub-data DATA1-1, and may provide an error-corrected 1-1st sub-data C_DATA1-1 to the first control core 1220. The error correction circuit 1250 may correct at least one error bit included the 2-1st sub-data DATA2-1, and may provide an error-corrected 2-1st sub-data C_DATA2-1 to the second control core 1230.

In an embodiment, the first control core 1220 may provide the error-corrected 1-1st sub-data C_DATA1-1 to the host core 1210. The second control core 1230 may provide the error-corrected 2-1st sub-data C_DATA2-1 to the host core 1210.

In an embodiment, the host core 1210 may provide the error-corrected 1-1st sub-data C_DATA1-1 and the error-corrected 2-1st sub-data C_DATA2-1 to the host 2000.

In an embodiment, the first storage region 1110 may store the first data related to vehicle driving, and the second storage region 1120 may store the second data of a different type from the first data. In an embodiment, the number of error bits included the first data and the second data may be different. Since the first data is the data having the write-intensive property and the second data is the data having the normal property, so the first data may have a smaller number of times by which the read operation is performed than the second data. When the number of performing the read operation is small, the possibility of error bis to occur is low, so the number of error bits included the first data may be less than the number of error bits included the second data.

Accordingly, the error correction circuit 1250 may perform the error correction operation on the 1-1st sub-data DATA1-1 and the 2-1st sub-data DATA2-1 by using different error correction codes.

For example, the error correction circuit 1250 may perform the error correction operation with respect to the 1-1st sub-data DATA1-1 by using a first error correction code, and may perform the error correction operation with respect to the 2-1st sub-data DATA2-1 by using a second error correction code. In an embodiment, the first error correction code may be a code having a lower error correction capability for correcting the error bit than that of the second error correction code. In an embodiment, the first error correction code may be a hamming code, and the second error correction code may be LDPC (Low Density Parity Check) code. In an embodiment, the time during which the error correction operation using the first error correction code is performed may be shorter than the time during which the error correction operation using the second error correction code is performed.

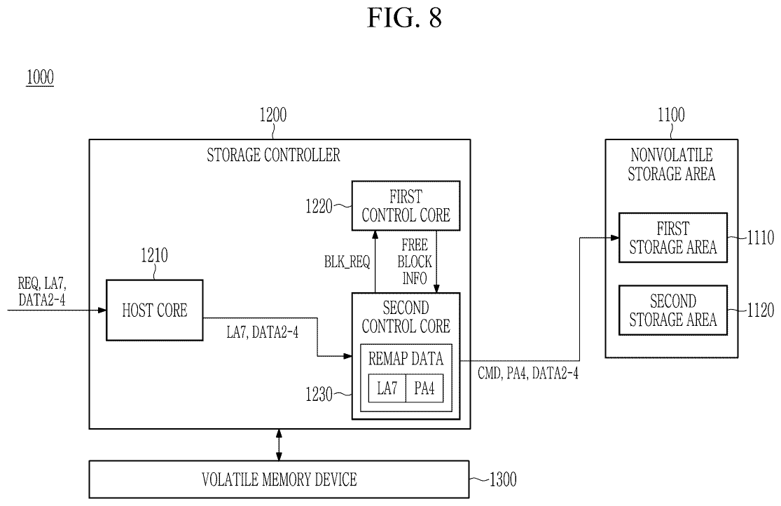

FIG. 8 is a drawing showing a storage device storing data based on address information of a free block according to an embodiment.

FIG. 8 will be explained with reference to FIG. 5. Referring to FIG. 5 and FIG. 8, the 2-1st sub-data DATA2-1 stored in the seventh memory block BLK7 included in the second storage region 1120 may be changed to invalid data as data having the same logical address as the seventh logical address LA7 corresponding to the 2-1st sub-data DATA2-1 is received. For example, when new data having the same logical address as the 2-1st sub-data DATA2-1 is received, the 2-1st sub-data DATA2-1 stored in the seventh memory block BLK7 is outdated and the status of the data is changed to invalid data.

In an embodiment, the host core 1210 may receive the write request REQ, the seventh logical address LA7, and a 2-4th sub-data DATA2-4 from the host 2000. The 2-4th sub-data DATA2-4 may include the second data type information. The second data type information may be information indicating that it is data of a different type from the first data type information indicating that it is data related to the vehicle driving. The 2-4th sub-data DATA2-4 may be data having the same logical address as the 2-1st sub-data DATA2-1 stored in the seventh memory block BLK7 included the second storage region 1120.

In an embodiment, the host core 1210 may provide the seventh logical address LA7 and the 2-4th sub-data DATA2-4 to the second control core 1230 based on the second data type information included in the 2-4th sub-data DATA2-4.

In an embodiment, the second control core 1230 may control the first storage region 1110 to store the data received from the host 2000 (e.g., the 2-4th sub-data DATA2-4 of the second data type) in a free block included in the first storage region 1110 based on the number of free blocks among the plurality of memory blocks included in the second storage region 1120. The free block may be a memory block in which no data is stored.

In an embodiment, when the number of free blocks included in the second storage region 1120 is greater than a preset number, the second control core 1230 may control the data received from the host 2000 to be stored in the second storage region 1120.

In an embodiment, when the number of free blocks included in the second storage region 1120 is smaller than the preset number, the second control core 1230 may transmit a free block allocation request BLK_REQ to the first control core 1220.

In an embodiment, the first control core 1220 may provide a free block address information FREE BLOCK INFO among the plurality of memory blocks included in the first storage region 1110 to the second control core 1230, in response to the free block allocation request BLK_REQ. For example, the first control core 1220 may provide a fourth physical address PA4 representing an address of the fourth memory block BLK4 that is a free block to the second control core 1230 as the free block address information FREE BLOCK INFO.

In an embodiment, the second control core 1230 may generate a re-map data REMAP DATA that re-maps the logical address received from the host 2000 and the physical address of the free block based on the free block address information FREE BLOCK INFO. For example, the second control core 1230 may generate the re-map data REMAP DATA that maps the seventh logical address LA7 corresponding to the 2-4th sub-data DATA2-4 and the fourth physical address PA4. The re-map data may be temporarily stored in the volatile memory device 1300.

In an embodiment, the second control core 1230 may provide the write command CMD, the physical address of the free block received from the first control core 1220, and data to the first storage region 1110. For example, the second control core 1230 may provide the write command CMD, the fourth physical address PA4, and the 2-4th sub-data DATA2-4 to the first storage region 1110. The 2-4th sub-data DATA2-4 may be stored in the fourth memory block BLK4 included the first storage region 1110.

In an embodiment, when the number of free blocks included in the second storage region 1120 is smaller than a preset number, the second control core 1230 may control the second storage region 1120 to perform a garbage collection operation for securing free blocks so that the number of free blocks is greater than the preset number. However, when the write operation of storing the 2-4th sub-data DATA2-4 in second storage region is performed after performing the garbage collection operation, a delay for the response to the write request of the host 2000 may be lengthened. Accordingly, when the number of free blocks included in the second storage region 1120 is smaller than a preset number, the second control core 1230 may receive address information of free block included the first storage region 1110 from the first control core 1220, and store the data the write request from the host 2000 in a free block included the first storage region 1110, and thereby, the write request of the host 2000 may be processed without delay. When the free block request is denied, the second control core 1230 may perform a garbage collection operation to secure more free blocks in the second storage region 1120.

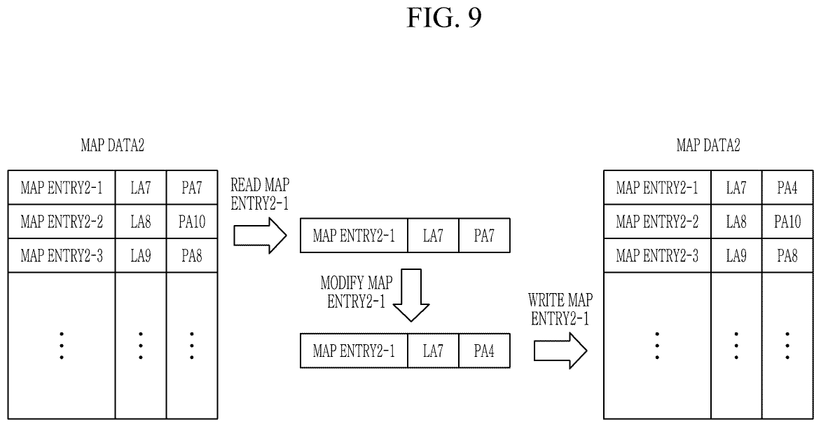

FIG. 9 is a drawing showing a storage device updating the map data according to an embodiment.

FIG. 9 will be explained with reference to FIG. 8. Referring to FIG. 8 and FIG. 9, the second control core 1230 may perform a map update operation of updating the physical address mapped with the logical address received from the host 2000 to the physical address of the free block received from the first control core 1220.

In an embodiment, when the 2-4th sub-data DATA2-4 having the same seventh logical address LA7 as the 2-1st sub-data DATA2-1 is received, the second control core 1230 may read the 2-1st map entry MAP ENTRY2-1 including the seventh logical address LA7 from the volatile memory device 1300. The 2-1st map entry MAP ENTRY2-1 may be data in which the seventh logical address LA7 and the seventh physical address PA7 are mapped. The seventh logical address LA7 may correspond to the 2-1st sub-data DATA2-1. The seventh physical address PA7 may correspond to the address of the seventh memory block BLK7 storing the 2-1st sub-data DATA2-1.

In an embodiment, the second control core 1230 may change the seventh physical address PA7 mapped with the seventh logical address LA7 to the fourth physical address PA4, which is the physical address of the free block received from the first control core 1220. The fourth physical address PA4 may correspond to an address of the fourth memory block BLK4 in which the 2-4th sub-data DATA2-4 is to be stored. The second control core 1230 may store the 2-1st map entry MAP ENTRY2-1, in which the seventh logical address LA7 and the fourth physical address PA4 are mapped, in the volatile memory device 1300.

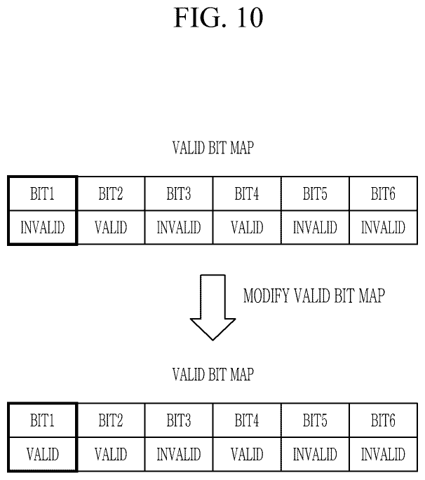

FIG. 10 is a drawing showing a storage device updating valid bit map data according to an embodiment.

Referring to FIG. 10, the volatile memory device 1300 may temporarily store valid bit map data VALID BIT MAP. The valid bit map data may be data representing whether the data stored in the plurality of memory blocks included in the non-volatile storage region 1100 is valid data.

In an embodiment, each of the first bit to sixth bits BIT1 to BIT6 may correspond to seventh to twelfth memory blocks BLK7 to BLK12 included in the second storage region 1120, respectively. For example, a first bit BIT1 may be data representing whether the data stored in the seventh memory block BLK7 is valid data. In an embodiment, the 2-1st sub-data DATA2-1 stored in the seventh memory block BLK7 may be changed to invalid data as data having the same logical address as the logical address corresponding to the 2-1st sub-data DATA2-1 is received. When the 2-1st sub-data DATA2-1 stored in the seventh memory block BLK7 is changed to invalid data, the first bit may correspond to an invalid data INVALID.

As an example, a second bit BIT2 may be data representing whether the data stored in the eighth memory block BLK8 is valid data. When the 2-3rd sub-data DATA2-3 stored in the eighth memory block BLK8 is a valid data, the second bit BIT2 may correspond to a valid data VALID.

As an example, a third bit BIT3 may be data representing whether the data stored in a ninth memory block BLK9 is valid data. When the ninth memory block BLK9 is a free block, third bit may correspond to the invalid data INVALID.

In an embodiment, when the 2-4th sub-data DATA2-4 having the same logical address as the seventh logical address LA7 corresponding to the 2-1st sub-data DATA2-1 stored in the seventh memory block BLK7 is received, the second control core 1230 may change the seventh physical address PA7 mapped with the seventh logical address LA7 to the fourth physical address PA4 corresponding to address of the fourth memory block BLK4 in which the 2-4th sub-data DATA2-4 is to be stored. In addition, since the memory block managed by the second control core 1230 is changed from the seventh memory block BLK7 to the fourth memory block BLK4, the memory block corresponding to the first bit BIT1 may be changed from the seventh memory block BLK7 to the fourth memory block BLK4. Since the valid data of the 2-4th sub-data DATA2-4 is stored in the fourth memory block BLK4, the second control core 1230 may change the first bit BIT1 to correspond to valid data.

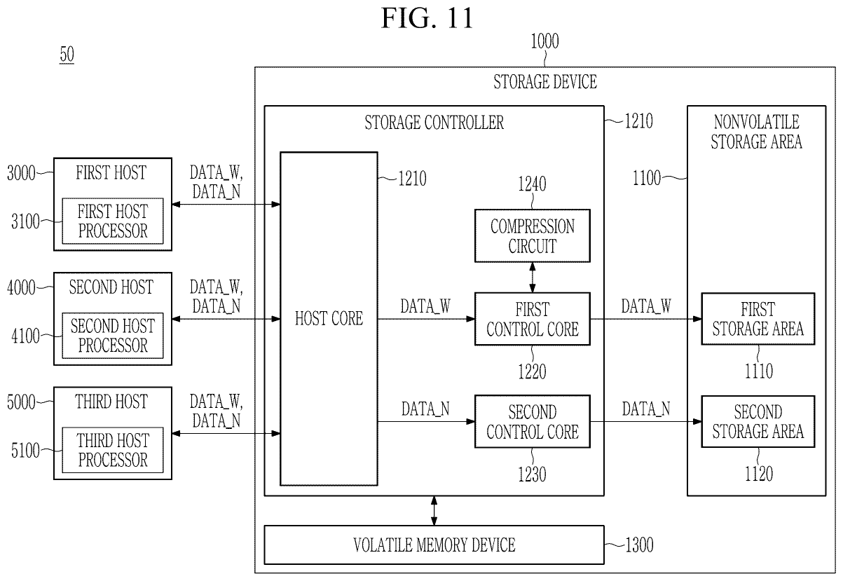

FIG. 11 is a drawing showing an electronic system distributing based on data property information according to an embodiment.

Referring to FIG. 11, the electronic system 50 may include the storage device 1000, a first host 3000, a second host 4000, and a third host 5000.

In an embodiment, the first host 3000 may include a first host processor 3100. The second host 4000 may include a second host processor 4100. The third host 5000 may include a third host processor 5100.

In an embodiment, the first host processor 3100, the second host processor 4100, and the third host processor 5100 may generate a write-intensive data DATA_W having the write-intensive property and a normal data DATA_N having the normal property.

In an embodiment, the write-intensive data DATA_W may have a smaller number of times by which the read operation is performed than the normal data DATA_N. The write-intensive data DATA_W may have a smaller number of times change to invalid data unlike the normal data DATA_N, as the write operations on the same logical address are repeated. In an embodiment, the write-intensive data DATA_W may include the vehicle driving data. The normal data DATA_N may include operation data.

The first host processor 3100, the second host processor 4100, and the third host processor 5100 may generate the first data property information indicating that the write-intensive data DATA_W is the write-intensive property. The first host processor 3100, the second host processor 4100, and the third host processor 5100 may generate the second data property information indicating that the normal data DATA_N is the normal property.

The first host processor 3100, the second host processor 4100, and the third host processor 5100 may provide the write-intensive data DATA_W including the first data property information and the normal data DATA_N including the second data property information to the storage device 1000.

In an embodiment, the host core 1210 may receive the write-intensive data DATA_W and the normal data DATA_N from the first host 3000, the second host 4000, and the third host 5000. The host core 1210 may distribute write-intensive data and normal data to different control cores based on the data property information.

In an embodiment, the host core 1210 may provide the write-intensive data DATA_W to the first control core 1220 based on the first data property information. The host core 1210 may provide the normal data DATA_N to the second control core 1230 based on the second data property information. The write-intensive data DATA W and the normal data DATA_N may be temporarily stored in the volatile memory device 1300 before being stored in the non-volatile storage region 1100.

In an embodiment, the first control core 1220 may control the operation of the first storage region 1110. The first control core 1220 may control the write operation of storing the write-intensive data DATA_W in the first storage region 1110. The second control core 1230 may control the operation of the second storage region 1120. The second control core 1230 may control the write operation of storing the normal data DATA_N in the second storage region 1120.

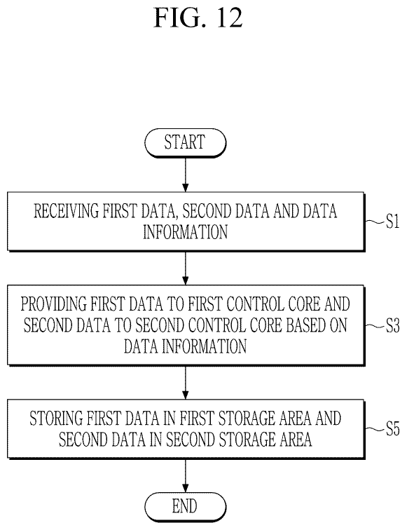

FIG. 12 is a flowchart showing a method of distributing data based on data information in a storage device according to an embodiment.

Referring to FIG. 12, at step S1, the host core 1210 may receive the first data, the second data, and the data information. In an embodiment, the first data may include the vehicle driving data related to vehicle driving. The first data may be write-intensive data having the write-intensive property. The second data may be normal the data having the normal property. The data information may include the data type information representing the types of the first data and the second data. The data information may include the data property information representing properties of the first data and the second data.

At step S3, the host core 1210 may provide the first data to the first control core 1220 based on the data information, and may provide the second data to the second control core 1230. In an embodiment, the first control core 1220 may be a core dedicated to processing the first data. In an embodiment, the second control core 1230 may be a core configured to process a remaining data excluding the first data, among data received from the host.

At step S5, the first control core 1220 may store the first data in the first storage region 1110, and the second control core 1230 may control the second data to be stored in the second storage region 1120.

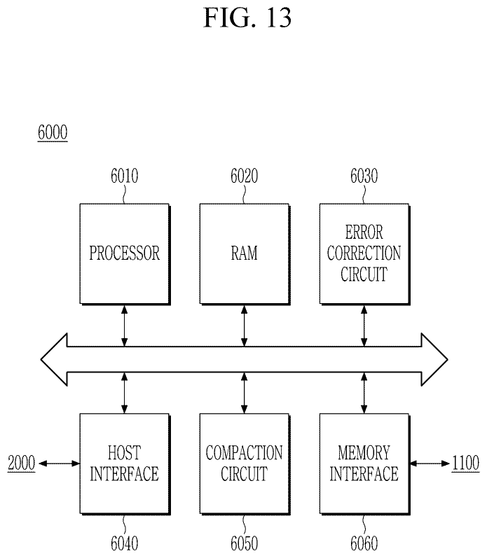

FIG. 13 is a drawing showing a configuration of a storage controller according to an embodiment.

Referring to FIG. 13, a storage controller 6000 may include a processor 6010, a RAM 6020, an error correction circuit 6030, a host interface 6040, a compression circuit 6050, and a memory interface 6060.

The processor 6010 may control an overall operation of the storage controller 6000. The processor 6010 may control the operation of the storage controller 6000 to store the data requested from the host 2000 in the non-volatile storage region 1100. In an embodiment, the processor 6010 may include the plurality of cores. In an embodiment, the processor 6010 may include the first control core 1220 and the second control core 1230.

A RAM 2120 may be used as a buffer memory, cache memory, operating memory, or the like of the storage controller 6000. In an embodiment, the RAM 6020 may store the map data and valid bit the map data. The map data and the valid bit map data may be read from the non-volatile storage region 1100.

The error correction circuit 6030 may perform the error correction operation. In an embodiment, the error correction circuit 6030 may perform an error correction encoding (ECC encoding) with respect to data to be stored in the non-volatile storage region 1100 through the memory interface 6060. The error correction encoded data may be transferred to the non-volatile storage region 1100 through the memory interface 6060.

In an embodiment, the error correction circuit 6030 may perform an error correction decoding (ECC decoding) with respect to data received from the non-volatile storage region 1100. In an embodiment, the error correction circuit 6030 may perform the error correction decoding with respect to the first data related to vehicle driving and the second data of a different type from the first data by using different error correction codes.

The compression circuit 6050 may compress data to be stored in the non-volatile storage region 1100. The compressed data may be provided in the non-volatile storage region 1100.

The storage controller 6000 may communicate with the host 2000 through the host interface 6040. The storage controller 6000 may receive data through the host interface 6040. In an embodiment, the host interface 6040 may be executed by the host core 1210. The host interface 6040 may receive the first data and the second data of a different type from the first data related to vehicle driving. The host interface 6040 may distribute the first data and the second data to different control cores based on the data type information representing the types of the first data and the second data.

The storage controller 6000 may communicate with the plurality of non-volatile memory devices included in the non-volatile storage region 1100 through the memory interface 6060. The storage controller 6000 may provide commands, addresses, data, and the like to the non-volatile storage region 1100 through the memory interface 6060.

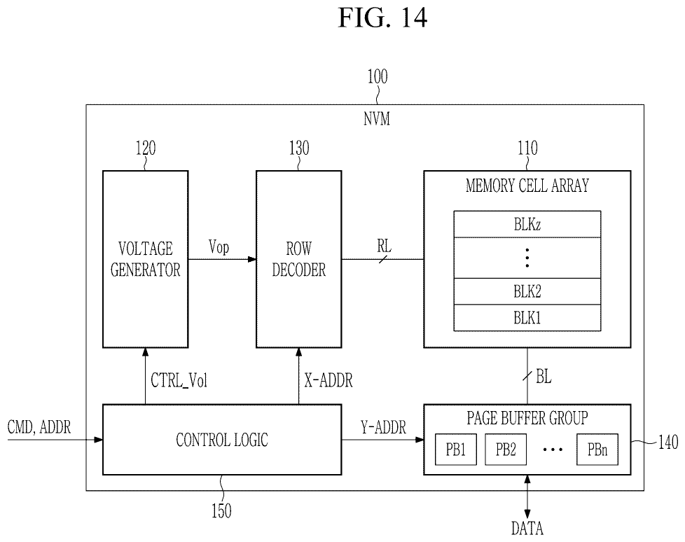

FIG. 14 is a drawing for explain a configuration of the non-volatile memory device.

Referring to FIG. 14, the non-volatile memory device 100 may be one of the first to sixth non-volatile memory devices 1111 to 1113 and 1121 to 1123 shown in FIG. 5. The non-volatile memory device 100 may include a memory cell array 110, a voltage generator 120, a row decoder 130, a page buffer group 140, and a control logic 150.

The memory cell array 110 may include the plurality of memory blocks BLK1 to BLKz. The plurality of memory blocks BLK1 to BLKz may be connected to the row decoder 130 through row lines RL. The plurality of memory blocks BLK1 to BLKz may be connected to the page buffer group 140 through bitlines BL. Each of the plurality of memory blocks BLK1 to BLKz may include a plurality of memory cells. In an embodiment, the plurality of memory cells may be non-volatile memory cells.

The voltage generator 120 may generate operating voltages Vop by using an external power voltage supplied to the non-volatile memory device 100. The voltage generator 120 may operate in response to the control of control of the control logic 150.

In an embodiment, the voltage generator 120 may generate the operating voltages Vop used for the program operation, the read operation, and the erase operation. For example, the voltage generator 120 may generate erase voltage, program voltage, pass voltage, read voltage, and erase voltage. The operating voltages Vop may be supplied to the memory cell array 110 by the row decoder 130.

The row decoder 130 may be connected to the memory cell array 110 through the row lines RL. The row lines RL may include drain selection lines, wordlines, and source selection lines.

The row decoder 130 may be configured to operate in response to the control of the control logic 150. The row decoder 130 may receive a row address X-ADDR from the control logic 150. In an embodiment, the row decoder 130 may select at least one wordline among a plurality of wordlines based on based on the row address X-ADDR, and may apply the operating voltages Vop provided from the voltage generator 120 to at least one wordline.

In an embodiment, during a program operation, the row decoder 130 may apply a program voltage to the selected wordline among the plurality of wordlines, and may apply a pass voltage of a lower level than the program voltage to non-selected wordlines. During a program verification operation, the row decoder 130 may apply a verification voltage to the selected wordline, and may apply a verification pass voltage of a higher level than the verification voltage to non-selected wordlines.

During the read operation, the row decoder 130 may apply a read voltage to the selected wordline, and may apply a read pass voltage of a higher level than the read voltage to non-selected wordlines.

A page buffer group 123 may include a plurality of page buffers PB1 to PBn.

The plurality of page buffers PB1 to PBn may be connected to the memory cell array 110 through the bitlines BL, respectively. The plurality of page buffers PB1 to PBn may operate in response to the control of control of the control logic 150.

In an embodiment, the plurality of page buffers PB1 to PBn may receive data DATA from the outside. The plurality of page buffers PB1 to PBn may select at least one bitline among the bitlines BL based on a column address Y-ADDR received from the control logic 150.

In an embodiment, during the program operation, the plurality of page buffers PB1 to PBn may transfer the data received from the outside to the memory cells of the memory cell array 110 through the bitlines BL. The memory cells may be programmed according to the received data. During the program verification operation, the plurality of page buffers PB1 to PBn may sense data stored in the memory cells through the bitlines BL.

During the read operation, the plurality of page buffers PB1 to PBn may sense data stored in the memory cells through the bitlines BL, and may store the sensed data to the plurality of page buffers PB1 to PBn.

The control logic 150 may be connected to the voltage generator 120, the row decoder 130, and the page buffer group 140. The control logic 150 may be configured to control the overall operation of the non-volatile memory device 100. The control logic 150 may operate in response to the command CMD transferred from the outside. The control logic 150 may generate various signals in response to the command CMD and the address ADDR and control the voltage generator 120, the row decoder 130, and the page buffer group 140.

While this invention has been described in connection with what is presently considered to be practical exemplary embodiments, it is to be understood that the invention is not limited to the disclosed embodiments. On the contrary, it is intended to cover various modifications and equivalent arrangements included within the spirit and scope of the appended claims.

What is claimed is:

1. A storage device, comprising:
a non-volatile memory storage comprising a first storage region and a second storage region;
a first controller configured to control the first storage region;
a second controller configured to control the second storage region; and
a host interface configured to receive first data and first data type information representing a first data type of the first data, provide the first data to the first controller based on the first data type information, receive second data and second data type information representing a second data type of the second data, and provide the second data to the second controller based on the second data type information,
wherein the first data type of the first data is different from the second data type of the second data.

2. The storage device of claim 1,
wherein the first controller is configured to:
configure the first storage region into a plurality of stripe blocks, and
access the first storage region in a unit of one stripe block of the plurality of stripe blocks, and
wherein the first controller is configured to store the first data in a corresponding one stripe block among the plurality of stripe blocks.

3. The storage device of claim 2, wherein:
the non-volatile memory storage comprises a plurality of non-volatile memory devices, each of the plurality of non-volatile memory devices having a plurality of memory blocks; and
the one stripe block comprises one of the plurality of memory blocks in each non- volatile memory device of the plurality of non-volatile memory devices.

4. The storage device of claim 2, wherein:
the second data comprises a first sub-data having the second data type and a second sub-data having a third data type different from the first data type and the second data type; and
the second controller is configured to control the second storage region to store the first sub-data in a first memory block included in the second storage region, and store the second sub-data in a second memory block included in the second storage region.

5. The storage device of claim 4, wherein:
the first controller is configured to generate a first map entry corresponding to the first data;
the second controller is configured to generate a first sub-map entry corresponding to the first sub-data and a second sub-the map entry corresponding to the second sub-data; and
a size of the first map entry is greater than each of the first sub-map entry and the second sub-the map entry.

6. The storage device of claim 4, further comprising:
an error correction circuit configured to perform an error correction operation on the first data read from the first storage region using a first error correction code and the second data read from the second storage region using a second error correction code different from the first error correction code.

7. The storage device of claim 4,
wherein the second controller is configured to control the first storage region to store a third sub-data comprising the second data type information in the first storage region based on a number of free blocks comprised in the second storage region.

8. The storage device of claim 7,
wherein, when the number of free blocks comprised in the second storage region is smaller than a preset number, the second controller is configured to transmit a free block allocation request to the first controller.

9. The storage device of claim 8,
wherein the first controller is configured to provide a physical address of a first free block comprised in the first storage region to the second controller in response to the free block allocation request.

10. The storage device of claim 9,
wherein the second controller is configured to control the first storage region to store the third sub-data in the first free block comprised in the first storage region based on the physical address of the first free block.

11. The storage device of claim 10,
wherein a logical address corresponding to the third sub-data is identical to a logical address corresponding to the first sub-data.

12. The storage device of claim 11,
wherein the second controller is configured to change a physical address of the first memory block mapped with the logical address corresponding to the first sub-data to the physical address of the first free block comprised in the first storage region.

13. The storage device of claim 1, further comprising:
a compression circuit configured to compress the first data received from the first controller and provide the compressed first data to the first storage region.

14. An electronic system, comprising:
a host processor configured to generate first data related to vehicle driving information and second data related to an operation of the electronic system;
a central controller configured to generate a first data type information indicating that the first data is related to the vehicle driving information and a second data type information indicating that the second data is related to the operation of the electronic system, wherein the first data type information is different from the second data type information; and
a storage device comprising a non-volatile storage comprising a first storage region and a second storage region,
wherein the storage device is configured to:
receive the first data and the first data type information from the central controller, store the first data in the first storage region based on the first data type information,
receive the second data and the second data type information from the central controller, and
store the second data in the second storage region based on the second data type information.

15. The electronic system of claim 14,
wherein the central controller comprises:
a first file system configured to receive the first data and generate the first data type information from the first data; and
a second file system configured to receive the second data and generate the second data type information from the second data.

16. The electronic system of claim 14,
wherein the storage device is configured to:
receive a write request and a third data from the central controller, and
store the third data in a first free block comprised in the first storage region based on a number of free blocks comprised in the second storage region.

17. The electronic system of claim 16,
wherein the storage device is configured to further receive the second data type information indicating that the third data is related to the operation of the electronic system.

18. The electronic system of claim 16,
wherein the storage device comprises:
a first controller configured to output a physical address of the first free block comprised in the first storage region; and
a second controller configured to store the third data in the first free block comprised in the first storage region based on the physical address of the first free block.

19. A storage controller, comprising:
a host core configured to receive first data having a write-intensive property and first data property information indicating that the first data have the write-intensive property through a channel connected to a host, receive second data having a normal property and second data property information indicating that the second data have the normal property through the channel, and transmit the first data and the second data to different control cores based on the first data property information and the second data property information;
a first control core configured to store the first data in a first storage region of a non-volatile memory storage; and
a second control core configured to store the second data in a second storage region of the non-volatile memory storage.

20. The storage controller of claim 19,
wherein a number of read operations performed on the first data is smaller than a number of read operations performed on the second data such that the first data has the write-intensive property.
